(19) United States
(12) Patent Application Publication
(10) Pub. No.: US 2009/0119386 A1
(43) Pub. Date: May 7, 2009

(54) METHOD AND ARRANGEMENT FOR DATA TRANSMISSION BETWEEN PEER-TO-PEER NETWORKS

(76) Inventors: Jen-Uwe Busser, Munchen (DE); Markus Bohm, Munchen (DE); Uwe Leutritz, Steinhoring (DE); Steffen Rusitschka, Munchen (DE)

Correspondence Address: K&L Gates LLP, P.O. BOX 1135, CHICAGO, IL, 60690, US

(21) Appl. No.: 12/300,261

(22) PCT Filed: May 2, 2007
(86) PCT No.: PCT/EP07/54243

§ 371 Date: Dec. 8, 2008

(30) Foreign Application Priority Data
May 9, 2006 (DE) 10-2006-021-591.5

(51) Int. Cl. G06F 15/16

(52) U.S. Cl. 709/218

(57) ABSTRACT

A method for data transmission between a first peer device (P1) in a first peer-to-peer network (P2P1) and a target peer device (P2′) in a second peer-to-peer network (P2P2), where each peer device (P1, P1′, P2′) has a node address (NID1, NID1′, NID2′) in its respective peer-to-peer network (P2P1, P2P2) and a network address (IP1, IP1′, IP2′) in a superordinate communication network (IN), with a search request (S1) for the target peer device (P2′) being sent from the first peer-to-peer network (P2P1) to at least one second peer device (P1′) in the second peer-to-peer network (P2P2) with a statement indicating the network address (IP1) C of the first peer device (P1).

### CLAIM FOR PRIORITY

This application is a national stage application of PCT/EP2007/054243, filed May 2, 2007, which claims the benefit of priority to German Application No. 10 2006 021 591.5, filed May 9, 2006, the contents of which hereby incorporated by reference.

### TECHNICAL FIELD OF THE INVENTION

The present invention relates to a method for transmission of data between different peer-to-peer networks, to a suitable peer device and to a corresponding network arrangement.

### BACKGROUND OF THE INVENTION

Peer-to-peer systems can be used to network to one another a multiplicity of appliances, which are referred to in the following text as peer devices, without any central devices, such as servers. In this case, certain services which are carried out in normal client-server architectures by the respective central unit, the server, must be provided by the peer devices themselves. One particularly important functionality in this case is address resolution, that is to say the conversion of known data of the user, as required in order to make contact with a specific peer, to the network address of its appliance or its peer device. Known data may in this case, for example, be the user name, a telephone number or designations which characterize other peer devices. The Internet is frequently used as a superordinate communication network using the known Internet Protocol TCP/IP, as a result of which the network address generally comprises the IP address and the port of the peer. The expressions peer and peer device are used in the following text, but expressions such as network element, component, communication terminal, subscriber, instance or station are also frequently used.

In this case, the communication between peers takes place via the protocol of the superordinate communication network, which is generally the Internet. The actual peer-to-peer network is then formed by a group of peers which each have a node ID or node address within the peer-to-peer P2P network. A data link between two peers in a P2P network first of all requires the determination of the network address of the requested peer from the node address which the requesting peer knows. In the case of so-called hybrid P2P networks, a server provides a central directory of the peers involved in the P2P network, in the form of their node address and corresponding network address. File interchange platforms such as Napster or iMesh, Audio Galaxy or SongSpy are based on a P2P network with a corresponding central directory service. This has the disadvantage that, if the central directory service fails, no more new communication links can be set up.

In order to avoid the dependency on a server with a central address directory, it is possible to flood the P2P network with search requests, that is to say to send request messages like a cascade to a large number of different peers, based on one requesting peer, until the peer being searched for answers. However, this procedure leads to a very high network load; furthermore, as the size of the network increases, ever fewer of the peers being search for will actually also be found. The Gnutella network may be mentioned as one example of this search strategy.

In other decentralized P2P networks, no central server or a distinguished peer is provided for a directory service. A requesting peer in this case dynamically searches for further peers in the P2P network and communicates with them in order to interchange data and information. The address resolution, that is to say the finding of the network address of the requested peer, which is characterized by a node address in the P2P network, is carried out dynamically by means of a routing protocol.

One possibility, for example, is to use a distributed hash table (DHT). In this case, the table, which associates an appropriate network address in the superordinate communication network with each peer and each node address, is distributed to all the peers involved in the P2P network. In the case of a logical arrangement of the peers and of the node addresses organized in the form of a ring, the peers may, for example, store a number of adjacent peers and/or node addresses and their network addresses in a local association or hash table. The node address area in this case has a metric which defines distances between peers and node addresses. One suitable algorithm for address resolution in a decentralized P2P network which is organized in the form of a ring is, for example, the Chord algorithm, which is described in Ion Stoica, Robert Morris, David Karger, M. Frans Kaashoek, Hari Balakrishnan: “CHORD: A Scalable Peer-to-Peer Lookup Service for Internet Applications, MIT-LCS-TR-819.

The association of a node address or node ID can be determined, for example, by application of a hash function to a user name of the relevant peer. Analogously, search terms such as file names may also be subjected to a hash function, producing a hash value. Each peer is associated with a range of hash values which, for example, are in turn arranged in a rising order. The first hash value of the range associated with a respective peer then corresponds, for example, to the node address of the relevant peer. By way of example, these define what data is available to a peer using the hashed file name.

A search for data or subscribers, and/or peers, is carried out by the requesting or searching peer calculating the hash value of the predetermined key word, such as the file name, user name or for example telephone number. In order to find the network address of the node ID which results from the hash process and is to be searched for, the requesting peer transmits a search request to a peer which is listed with its node address and associated network address in a list of known peers, for example a neighbor list and/or finger list, of the requesting peer. If the requested peer is responsible for the sought hash value, it transmits the requested data to the requesting peer via the superordinate network.

If the first requested peer is not responsible for the hash value, it responds with the address of a peer from its peer list whose node ID is more similar to the hash value being searched for than its own node address. Whether its own node ID is similar to the sought node ID or the sought hash value is evident from the metric used for the node address area. The peer to whom the first request was sent therefore transmits to the requesting peer a node ID and IP address which are closer to the sought hash value. The requesting peer can now transmit a second search request to the peer with the nearer node address. This procedure is continued until a peer is found which is responsible for the hash value and can supply the sought data.

With this decentralized configuration of the P2P network, all subscribing peers must be organized in a ring structure which results from the organized periodically progressed list of node addresses. For example, P2P networks are used to interchange files in exchange markets. However, address resolution with regard to the network address in the superordinate network is also particularly important in the case of so-called VOIP (voice over IP) transmissions, that is to say voice transmission over the Internet. For example, one P2P network for voice transmission is known by the name “Skype”. Subscribers to this network can interchange voice data with one another, and can thus use the Internet for telephony.

### SUMMARY OF THE INVENTION

The present invention addresses the problem of data transfer between different P2P networks, generally of different operators. The network address allocations of the respective other external peers are in principle unknown for peers in different P2P networks. In order to allow peers in different P2P networks to communicate with one another, it is, for example, possible to combine the P2P networks to form one network. This then results in a larger P2P network. The combination or joining of the external peers requires the interchange of a large number of stabilization messages in order to match the neighbor lists of the individual peers to one another, and/or new structuring. These messages must then be interchanged between the IP networks of the two operators. In the case of combination, for example, of two P2P rings, technical problems in the network of one operator also affect the quality of service for the subscribers of the other operator. This then makes it more difficult to separately license the number of final customers of the two operators.

Alternatively, it is proposed that a plurality of P2P networks be linked via so-called gateways. In this case, selected servers receive the incoming search request from external networks and carry out a search for the search request in their own P2P ring. The result of this search, that is to say for example a network address or IP address of a peer in their own network, is then transmitted back to the requesting network or the peer with the external operator. Gateways such as these must be very powerful in order to manage a large number of search requests. Problems also result as a result of desired cryptographic operations for the authentication of requests. In addition, if a gateway fails, no more search requests at all are possible between the different P2P networks.

The present invention therefore provides a simple method which allows safe, secure and reliable data interchange between peers in different peer-to-peer networks.

In one embodiment of the invention, there is a method for data transmission between a first peer device in a first peer-to-peer network and a destination peer device in a second peer-to-peer network, with each peer device having a node address in its respective peer-to-peer network and a network address in a superordinate communication network, with a search request for the destination peer device being sent from the first peer-to-peer network to at least one second peer-to-peer device in the second peer-to-peer network, stating the network address of the first peer device.

According to the invention, the address resolution of the sought peer is carried out in a peer-to-peer network which is different from the peer-to-peer network of the requesting peer, in that the network address of the requesting peer is transmitted to a peer device in the external network. There, address resolution of the sought peer in the external network can then be carried out until the destination peer is found, which can then set up the data link via the superordinate network to the requesting peer or its network address. The superordinate communication network is, for example, the Internet or comparable network structures.

In various aspects of the invention, there is a transmission of the search request stating a destination node address of the destination peer device in the second peer-to-peer network; carrying out a search in the second peer-to-peer network using a search algorithm with a distributed hash table for finding the network address of the destination peer device; and transmission of the network address of the destination peer device to the first peer device via the superordinate communication network.

As soon as the requesting peer device has received the network address of the destination peer device, a data link can then also be set up between the first peer device and the destination peer device via the superordinate communication network by means of the network addresses. The structure of the external P2P network is irrelevant for the requesting peer device. The search for the network address of the destination peer device is carried out using the protocol of the second peer-to-peer network. In the end, the data link is governed only by the network address. In another aspect of the invention, the search request of the first peer device is diverted to a further second peer device in the second peer-to-peer network, with the network address of the further peer device in the second peer-to-peer network being stored in a list. The storage of a list of peer devices in the second network itself allows advantageous preselection for the peer device in the second network, such that the destination node address with regard to the metric of the address area in the second peer-to-peer network is in the vicinity of the peer device from which the address resolution or the search in the second peer-to-peer network originates.

Furthermore, before the search request, a list of network addresses of second peer devices in the second peer-to-peer network can be transmitted to a passive peer device, the passive peer device being associated with the first peer device. This makes it possible to ensure that, for a search request from one's own peer-to-peer network, an active instance or, in the external destination network, a peer device which can be addressed via a network address is always produced, from which the search in the destination peer-to-peer network can start.

The invention also provides a peer device for a first peer-to-peer network having a node address in the first peer-to-peer network and having a network address in a superordinate communication network, with the peer device having an associated passive peer device which is peer-to-peer network independent and stores at least one network address of a peer device in a second peer-to-peer network, and with the passive peer device being designed such that it transmits a search request for a destination peer device in the second peer-to-peer network, stating the network address of the peer device to the at least one peer device (P1′) in the second peer-to-peer network. The peer device according to the invention is particularly suitable for carrying out the method according to the invention for data transmission between peer-to-peer networks. The passive peer device, which is also referred to as a passive instance in the peer-to-peer network, while the normal peer devices are active instances in the network, is not part of the peer-to-peer network. It merely provides one or more network addresses which are required for a search request in the external peer-to-peer network. For example, if the requesting peer device carries out a hash process for a subscriber name, as a result of which an external node address, that is to say a node address which is not associated with its own peer-to-peer network, is generated, the passive peer device passes this destination node address to a peer device in the external peer-to-peer network, which destination node address corresponds to the network address stored by the passive peer device. The search in the external network is carried out using a suitable search algorithm and returns the network address of the sought destination peer to the requesting peer device, since the passive peer device has passed on the network address of the requesting peer.

The passive peer device is therefore preferably not assigned a node address in one of the peer-to-peer networks, and also cannot be addressed by any of the other peer devices.

The peer device preferably has a stored partial hash table of a distributed hash table of the peer-to-peer network, which comprises an association of node addresses with network addresses.

In still another embodiment, the at least one peer device is implemented on a computer as an executable computer program with a stability program module for stabilization of the peer-to-peer network according to a peer-to-peer protocol, a memory program module for storage of data, and with a search program module for production of search requests, with the passive peer device accessing the search program module using the at least one network address of the peer device in the second peer-to-peer network.

Peer-to-peer networks, such as exchange markets, which operate so-called file sharing, can be set up from computers coupled to the Internet. The provision of a peer device according to the invention thus requires only the implementation of an additional passive peer device which transfers to the search program module the network address of a peer device in the second peer-to-peer network. In the simplest case, the passive peer device therefore comprises only a table with possible network addresses of external peer devices in order that the further address resolution is then carried out in the external peer-to-peer network. This therefore results in a minimal amount of additional complexity over conventional peer devices. The computer load resulting from the data transmission according to the invention between different peer-to-peer networks is also low since all that is necessary is to search for program modules which are stored in one's own peer-to-peer network.

In yet another embodiment of the invention, there is a network arrangement is provided having a first peer-to-peer network with first peer devices and at least one second peer-to-peer network with second peer devices, with at least one of the peer devices being designed in accordance with the invention.

In a network arrangement according to one embodiment of the invention, each peer device advantageously has an associated passive peer device. Particularly in the case of a computer implementation of the invention by means of the passive peer devices which are provided and may each in turn be in the form of a computer program, all peer-to-peer networks can be networked by means of this minimal additional complexity.

In another embodiment of the network arrangement, at least one peer device is provided as a load balancer, which passes on the search request of a passive peer device to a peer device in the respective peer-to-peer network. A load balancer, which preferably stores a list with peer devices which are active in the respective destination peer-to-peer network, and stores their network addresses, ensures that the search in the destination peer-to-peer network can always be carried out from one of its peer devices.

In still another embodiment, at least one peer device is provided as a rendezvous peer which, in response to a request of a passive peer device, produces at least one network address of a peer device in the respective destination peer-to-peer network. The list of passive peer devices with possible network addresses of peer devices in the destination peer-to-peer network can thus first of all be updated before a search request.

At least one of the peer-to-peer networks preferably operates with a distributed hash table and in particular with a Chord algorithm or a Kademlia algorithm for address resolution.

### BRIEF DESCRIPTION OF THE DRAWINGS

Further advantageous refinements and developments of the invention are the subject matter of the exemplary embodiments which will be explained in more detail in the following text, with reference to the figures, in which:

FIG. 1 shows a peer-to-peer network organized in the form of a ring.

FIG. 2 shows two P2P networks coupled according to the invention.

FIG. 3 shows a functional diagram of a peer device.

FIG. 4 shows two P2P networks, coupled according to the invention, with a rendezvous peer.

FIG. 5 shows a plurality of P2P networks coupled according to the invention.

Unless stated to the contrary, the same or functionally identical elements have been provided with the same reference symbols in the figures.

### DETAILED DESCRIPTION OF THE INVENTION

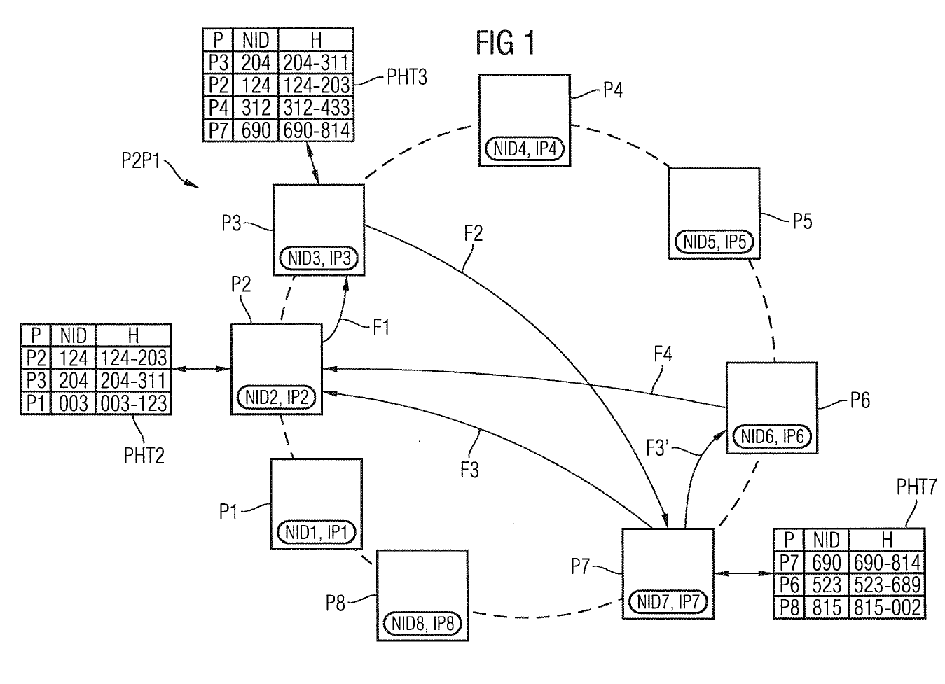

In order to explain the general problem of address resolution in peer-to-peer networks, FIG. 1 illustrates, by way of example, a P2P network organized in the form of a ring. Peer devices P1-P8 are provided and, for example, are in the form of computers which are connected to the Internet and have P2P software installed in them. Each peer thus has an IP address IP1-IP8 which identifies it in the Internet, and a node address NID1-NID8 which identifies it as a peer in the P2P network P2P1. By way of example, the following text explains the method of operation of the Chord algorithm for address resolution. However, other P2P protocols are also possible for decentralized P2P networks.

The node address of a peer is obtained, for example, by application of a suitable hash function to the name of the peer. By way of example, the name may be a user name or a telephone number. The hash value of a corresponding search word, for example of a telephone number, is associated with a node ID or a node address. A plurality of hash values can also be associated with one node address. For example, a node address NID1=003 may be associated with the peer P1, with the value NID1=003 indicating the start of a range of hash values for which the peer P1 is responsible. In a P2P network which uses 10-bit-broad hash values, for example, ranges of hash values indicated in the table can be associated with the respective peers.

| Peer | Customer address | Hash values |
|---|---|---|
| P1 | NID1 = 003 | H = 003 . . . 123 |
| P2 | NID2 = 124 | H = 124 . . . 203 |
| P3 | NID3 = 204 | H = 204 . . . 311 |
| P4 | NID4 = 312 | H = 312 . . . 433 |
| P5 | NID5 = 434 | H = 434 . . . 522 |
| P6 | NID6 = 523 | H = 523 . . . 689 |
| P7 | NID7 = 690 | H = 690 . . . 814 |
| P8 | NID8 = 815 | H = 815 . . . 002 |

Each peer therefore has an associated node address with a specific value, and a range of hash values H=hash (search term) produced from search terms.

The table therefore represents the complete table for the P2P network. This is not provided centrally by a server but is stored split between the individual peers P1-P8. Each peer knows the associated hash values of its neighbors, for example of the nearest neighbors. The peer P3 has stored the information that the peer P2 with the node address NID2=124 is responsible for hash values 124-203. Furthermore, the peer P3 knows its own responsibility for the hash values 204-311 and the responsibility of the adjacent peer P4 with the node address NID4 =312 for the hash values 312-434. In a generalized form, each peer has a partial hash table with the association of hash values of its peers which are adjacent in the node address area and, possibly, the association of the hash values of one or more finger peers, for example in the case of the peer P3, the association of the peer P7 with the node address NID7 =690 for the hash values 690-814. FIG. 1 illustrates a corresponding partial hash table PHT.

If a search request or file request for a search term which produces the hash value hash (search term)=530 is now started originating from the peer P2, the peer P2 transmits a search request F1 to the peer P3 stating its own network address IP2 and the sought hash value 530. The peer P3 is selected since, in the partial hash table PHT2 of the peer P2, the hash value 530 is closer to the responsibility range of the peer P3 with the hash values between 204 and 311 than the further peer P1, which is included in the partial hash table, with the responsibility range between H=003 and 123. A search request is therefore always transmitted to that peer in its own partial hash table whose node address in the node address area is closest to the hash value of the search term or of the destination node address.

The peer P3 then checks its partial hash table PHT3 and determines the peer P7 to be that peer whose responsibility range and associated hash values are closest to the sought hash value 530, and transmits a corresponding second search request F2. In its associated partial hash table PHT7, the peer P7 determines the peer P6 with the node address 523 to be the peer responsible for the hash value 530, and transmits this information to the originally requesting peer P2, whose network address IP2 is associated with the search requests F1, F2. Alternatively, if the peer P2 has sent a data request for the search term with the hash value 530, the peer P7 could transmit to the peer P6 the data request requirement from the peer P2 and its network address IP2 in a message F3′. The destination peer P6 then transmits directly to the requesting peer P2, or its IP address IP2, the data identified by the hash value 530, via a data link F4 in the communication network or Internet. An appropriate P2P protocol therefore allows address resolution of sought data, for example originating from the peer P2, for which no information is available about the memory location of these data items in the P2P network, since the partial hash table PHT2 associated with the peer P2 does not include this node address range.

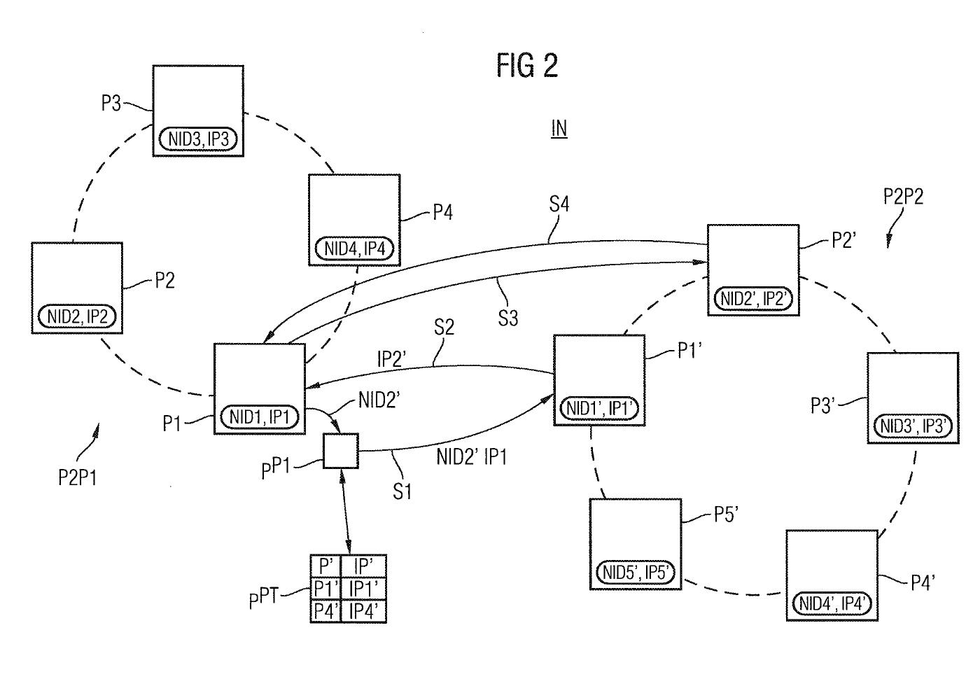

FIG. 2 shows two peer-to-peer networks P2P1, P2P2, respectively with peer devices P1-P4, P1′-P5′. The peer devices P1-P4, P1′-P5′ are respectively assigned network addresses IP1-IP4 and IP1′-IP5′, as well as node addresses NID1-NID4, NID1′-NID5′ in their respective P2P network. For simplicity, it is assumed here that the respective node address NID corresponds to the hash value of the peer or subscriber name. The two P2P networks P2P1, P2P2 illustrated in FIG. 2 are operated by different operators or providers. For example, it is feasible for the P2P networks to be used for VOIP transmission between their subscribers, who each use a peer device.

If subscribers within one operator P2P network wish to telephone one another or if peer devices within the P2P network communicate with one another, the address resolution is carried out for example as has been described with reference to FIG. 1. However, if a subscriber A which is operating the peer P1 wishes to communicate with a subscriber B which is operating the peer P2′ in the second P2P network P2P2, an embodiment of the method according to the invention must be used. In order to allow data interchange or data transmission between peers in different P2P networks, the peer P1, for example, has an associated passive peer device pP1. The passive peer device pP1 is designed as a passive instance in the respective network P2P1 such that it cannot store any data whatsoever from other peers, but can just transmit search requests to active instances, that is to say peers. The passive peer device pP1 in this case provides at least one IP address or network address of a peer device in an external peer-to-peer network.

By way of example, a data link between the peer P1 in the first peer-to-peer network P2P1 and the peer P2′ in the second peer-to-peer network P2P2 will be explained in the following text. The two P2P networks P2P1, P2P2 are implemented in a superordinate communication network, such as the Internet IN. The subscriber A has, for example, as a node address NID1, the hash value of its subscriber name, for example hash(subscriberA@operator1). The subscriber B, which is connected to the second P2P network P2P2 has, for example, a node address NID2′ hash(subscriberB@operator2). If the peer device P1 wishes to set up a link via the Internet IN to the peer P2′, the peer device P1 determines that the node address NID2′ is located in the external peer-to-peer network P2P2. In consequence, the passive peer device pP1 is activated, and provides the peer table pPT with active instances or peers of the external P2P network P2P2 and their network addresses or IP addresses IP′. The passive peer device pP1 itself has no node address for one of the P2P networks but is designed merely such that it can transmit search requests to a peer P1′ in the external network P2P2, stating a destination node address and preferably the network address IP1 of its peer P1.

The passive peer device PP1 therefore transmits a search request S1 via the Internet IN stating the destination node address NID2′ and the own IP address IP1 of the requesting peer pP1 to the IP or network address IP1′ of the peer P1′ in the external peer-to-peer network P2P2. The sought destination peer P2′ can thus now be found using a suitable search algorithm in the peer-to-peer network P2P2.

In the example illustrated in FIG. 2, the node address NID2′ is recorded in the partial hash table or neighbor list of the peer P1′. This means that the peer P1′ transmits the network address IP2′ of the destination peer P2′ to the IP address IP1 of the requesting peer pP1 from the P2P network P2P1. Address resolution can therefore be carried out originating from the peer pP1 for a destination peer P2′ in an external peer-to-peer network P2P2.

In a further step S3, the passive peer pP1 can now make a request to the destination peer P2′ with the IP address or network address IP2′. A data link is now possible between the IP addresses IP1, IP2′, as is indicated by the arrow S4 in FIG. 2, via the superordinate communication network, in this case the Internet IN. The use of a passive peer pP1, which is associated with the peer P1, thus makes it possible to export a search request to the destination P2P network, where this is carried out using the search algorithm that is valid there.

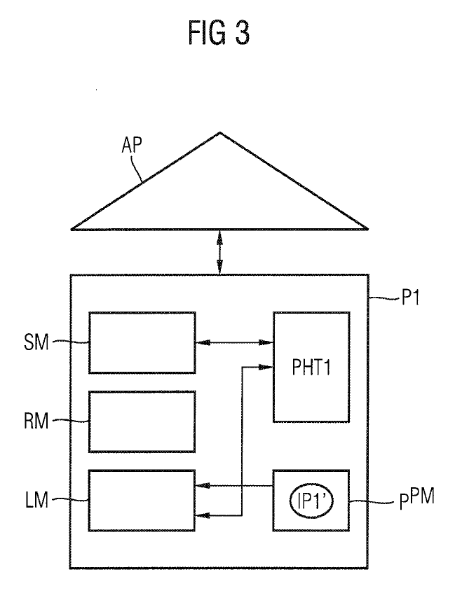

FIG. 3 schematically shows the configuration of a peer device P1 according to one embodiment of the invention. In particular, a peer device P1 may be computer-implemented as executable software on a computer. To this end, a corresponding computer program or peer P1 has a stability program module SM, a memory program module RM, a search program module LM and a program module pPM for the passive peer. Furthermore, further modules such as a module for provision of the partial hash table PHT1 with the respective neighbor peer and peer addresses for the search algorithm or the search module LM may be provided.

The peer P1 or the peer software generally interacts with superordinate application software AP, which is used to provide the respective computer function. By way of example, this may be VOIP software, the software for file sharing or other applications in which peer-to-peer communication is desired. The stability program module is used, inter alia, to update the neighbor table PHT1 and the associated partial hash table of the peer P1 if additional peers enter the P2P network, or peers fail. The stability program module has suitable stability algorithms which each ensure a partial hash table that is appropriate for the peer P1.

The memory program module RM is used, for example, to store data or files which are intended to be made available to the P2P network. For example, these may be addresses, telephone numbers, user names or file names. By way of example, the search program module LN provides the search algorithms, which are being explained with reference to FIGS. 1 and 2, in the peer-to-peer network. The search program module in this case accesses the partial hash table PHT1 of the peer 1 and produces appropriate search requests which, for example, comprise the destination node address and the own network address. The passive peer module pPM has access to the search program module LM and supplies it with the network address of a peer in an external network as an IP address for a peer which can further process the search request.

This is done when the peer P1 wish to communicate with a peer which has a destination node address which is not associated with its own P2P network. The search program module thus produces a standard search request, with the search message being transmitted to an IP address outside its own P2P network, since the passive peer module pPM intervenes.

In consequence, it is possible for example, to carry out address resolution as has been explained with reference to FIG. 2. Since the program modules for stabilization of the own P2P network SM, for storage RM and for production of search requests LM are normally stored in peer devices or appropriate software, the addition of a passive peer module pPM results in only a small amount of additional complexity. Since the passive peer module is not assigned any node address whatsoever, the network structure of the respective P2P network also does not become any more complex, overall.

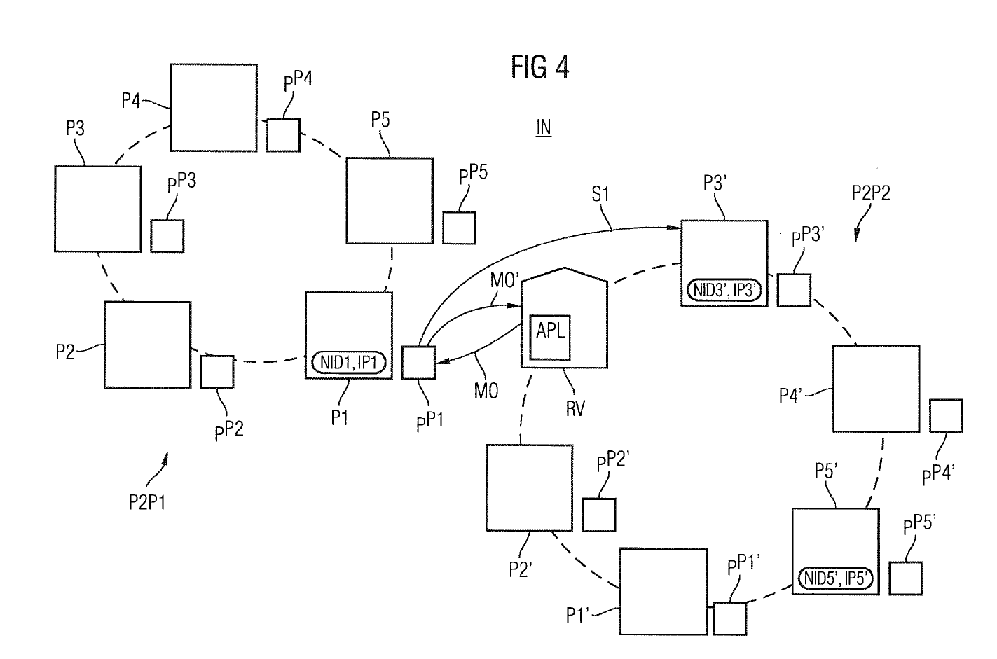

FIG. 4 illustrates a further possible refinement of the invention. A first peer-to-peer network P2P1 with peer devices P1-P5 is provided, in which each peer device P1-P5 has an associated passive peer device pP1-pP5. In a similar manner, a second peer-to-peer network P2P2 is formed with peer devices P1′-P5′, with each peer P1′-P5′ also having an associated passive peer device pP1′-pP5′. Since each peer P1-P5, P1′-P5′ is assigned a passive instance in the form of the passive peer device, each of the peer devices can use the search algorithm of the respective destination peer-to-peer network when a search request occurs for files or information in external peer-to-peer networks, as has already been described in more detail above.

In the second peer-to-peer network P2P2, one peer device is in the form of a rendezvous peer RV. This rendezvous peer RV provides a list of network addresses of active peers in the second peer-to-peer network P2P2, with one of these IP addresses of the peers which is recorded in a list APL being made available to a passive peer pP1 in the first network P2P1 when a search request has to be made from the P2P network P2P1 to the second P2P network P2P2. The rendezvous peer RV provides a respective passive peer pP1, that is to say always a selection of peers in the network P2P2, which are active and can start the search algorithms of the P2P2.

Thus, if a request originates, for example, from the peer P1 in the first peer-to-peer network P2P1, with the corresponding peer or subscriber being located in the second P2P network, the passive peer pP1 first of all checks in a request M0′ with the rendezvous peer RV for possible IP addresses of peers in the second network to which a subsequent search request may be passed. The rendezvous peer checks its list APL and transmits one or more appropriate IP addresses, for example of the peer P3′ in a corresponding message M0 to the passive peer pP1. The passive peer pP1 then generates a search request stating the node address, for example NID5′, the IP address of its peer P1 as the start address for the search request, and the IP address of the requested peer IP3′. This search request S1 is passed to the peer P3′ which then starts the search algorithm in the second peer-to-peer network P2P2. A rendezvous peer RV therefore ensures that a suitable IP address for a peer in the destination peer-to-peer network to which a search request can be determined is always provided for a passive peer.

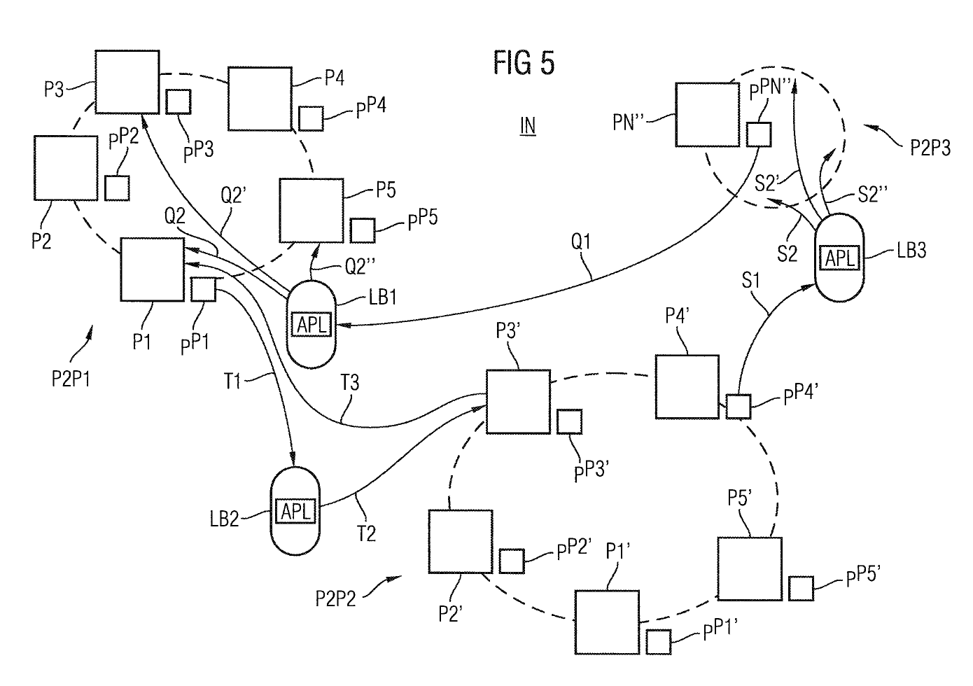

FIG. 5 shows a further embodiment of the invention. By way of example, this shows three peer-to-peer networks P2P1, P2P2, P2P3 with peer devices P1-P5, P1′-P5′, PN″, with each peer device having an associated passive peer device pP1-pP5, pP1′-pP5′, pPN″. Furthermore, each P2P network has at least one associated load balancer LB1, LB2, LB3, which is responsible for search requests from external passive peer devices.

The first message in a search request from a passive peer to a destination P2P network is in this embodiment of the invention always made as shown in FIG. 5 to the load balancer LB1, LB2, LB3. This load balancer passes the search request either to any given peer from a list of active peers in the destination network or preferably actually to the peer whose node address is closest to the destination node address. For example, the passive peer pP1 transmits its search request T1 to the load balancer LB2 in the second peer-to-peer network P2P2. This decides that the peer P3′ is closest to the sought destination node address, for example NID4′, and passes the search request to the peer P3′. The peer P3′ responds to the search request from the passive peer pP1 with a message T3 which, for example, contains the network address IP4′ of the destination peer 4′. The peers P1 and P4′ can then set up a data link between their IP addresses IP1 and IP4′.

In this case, the load balancers LB1, LB2, LB3 need not be in the form of active instances in the P2P networks. It is sufficient for a respective list with active peers APL to be available to the load balancers LB1, LB2, LB3 in order to pass on search requests advantageously. The larger the list of the load balancer, the better it can distribute the load of the search requests arriving externally in its destination peer-to-peer network. As has been explained in FIG. 4, the load balancer can also be designed identically to a rendezvous peer. A corresponding combined peer device then first of all passes a list of active peers to the requesting passive peer device. A plurality of load balancers may also be provided, whose IP addresses are then transmitted before a search request to corresponding passive peer devices. The reliability of data requests between different peer-to-peer networks is further improved by means of appropriate redundancy of rendezvous peers or load balancer peers.

Although the present invention has been explained in more detail with reference to preferred embodiments, it is not restricted to them but can be modified in many ways. For example, the invention can be used for VOIP applications or a file sharing application.

Although the invention has been described essentially on the basis of a Chord algorithm for the search of addresses or data in the P2P network, other organization forms of P2P networks may also be used. Furthermore, the Kademlia search algorithm has been mentioned merely by way of example.

Further superordinate communication networks in addition to the Internet are also feasible. Similar networks are, for example, provided in the case of ISDN, GSM or UMTS communication networks. Gateways between peer-to-peer networks also occur, for example, in the case of telephone calls between subscribers to different mobile radio networks. The invention achieves a higher degree of safety, security and stability of the networks since, furthermore, separate P2P networks exist. There is no need to use particularly powerful gateway computers.

1. A method for data transmission between a first peer device in a first peer-to-peer network and a destination peer device in a second peer-to-peer network, with each peer device having a node address in its respective peer-to-peer network and a network address in a superordinate communication network, comprising sending a search request for the destination peer device from the first peer-to-peer network to at least one second peer device in the second peer-to-peer network, stating the network address of the first peer device.

2. The method as claimed in claim 1, further comprising:
transmitting the search request stating a destination node address of the destination peer device in the second peer-to-peer network;
performing a search in the second peer-to-peer network using a search algorithm with a distributed hash table for finding the network address of the destination peer device; and
transmitting the network address of the destination peer device to the first peer device via the superordinate communication network.

3. The method as claimed in claim 2,
wherein a data link is set up between the first peer device and the destination peer device via the superordinate communication network by the network addresses.

4. The method as claimed in claim 2, wherein
the search request is diverted to another second peer device in the second peer-to-peer network, with the network address of the another second peer device being stored in a list.

5. The method as claimed in claim 2, wherein
wherein, before the search request, a list of network addresses of the second peer devices is transmitted to a passive peer device, which is associated with the first peer device.

6. A peer device for a first peer-to-peer network comprising:
a node address in the first peer-to-peer network;
a network address in a superordinate communication network, with the peer device having an associated passive peer device which is peer-to-peer network independent and stores at least one network address of a peer device in a second peer-to-peer network, and with the passive peer device configured such that it transmits a search request for a destination peer device in the second peer-to-peer network, stating the network address of the peer device to the at least one peer device in the second peer-to-peer network.

7. The peer device as claimed in claim 6,
wherein the passive peer device has a list with a selection of network addresses of peer devices in the second peer-to-peer network.

8. The peer device as claimed in claim 6, wherein
the passive peer device is not assigned a node address in a peer-to-peer network and cannot be addressed by other peer devices.

9. The peer device as claimed in claim 6,
wherein the peer device has a stored partial hash table of a distributed hash table of the peer-to-peer network with node addresses associated with network addresses.

10. The peer device as claimed in claim 6, wherein the peer device is implemented on a computer as an executable computer program with a stability program module for stabilization of the peer-to-peer network according to a peer-to-peer protocol, a memory program module for storage of data, and with a search program module for production of search requests, with the passive peer device accessing the search program module using the at least one network address of the peer device in the second peer-to-peer network.

11. A network arrangement having a first peer-to-peer network with first peer devices and at least one second peer-to-peer network with second peer devices, with at least one of the peer devices comprising a node address in the first peer-to-peer network; a network address in a superordinate communication network, with the peer device having an associated passive peer device which is peer-to-peer network independent and stores at least one network address of a peer device in a second peer-to-peer network, and with the passive peer device configured such that it transmits a search request for a destination peer device in the second peer-to-peer network, stating the network address of the peer device to the at least one peer device in the second peer-to-peer network.

12. The network arrangement as claimed in claim 11,
wherein each peer device has an associated passive peer device.

13. The network arrangement as claimed in claim 11,
wherein the search request comprises a statement of a destination node address of the destination peer devices in the second peer-to-peer network.

14. The network arrangement as claimed in claim 11, wherein at least one peer device is provided as a load balancer, which passes on the search request of a passive peer device to a peer device in the respective peer-to-peer network.

15. The network arrangement as claimed claim 11, wherein at least one peer device is provided as a rendezvous peer which, in response to a request of a passive peer device, produces at least one network address of a peer device in the respective destination peer-to-peer network.

16. The network arrangement as claimed in claim 11, wherein at least one peer-to-peer network is configured with a distributed hash table and in particular with a Chord algorithm or a Kademlia algorithm for address resolution.
